(19) United States
(12) Patent Application Publication
(10) Pub. No.: US 2018/0160859 A1
(43) Pub. Date: Jun. 14, 2018

(54) SANDWICH CUTTER AND MOULD

(71) Applicant: The Lunchies Co. Limited, Suffolk (GB)

(72) Inventor: Ian Burren, Suffolk (GB)

(73) Assignee: The Lunchies Co. Limited, Suffolk (GB)

(21) Appl. No.: 15/840,134

(22) Filed: Dec. 13, 2017

Related U.S. Application Data
(60) Provisional application No. 62/433,947, filed on Dec. 14, 2016.

(51) Int. Cl. A47J 43/20; B26D 3/10; B26F 1/44

(52) U.S. Cl. CPC A47J 43/20; B26D 3/10; B26F 2001/4418; B26D 2210/02; B26F 1/44

(57) ABSTRACT

A mould for a sandwich, the mould comprises: a base portion and a lid portion; said base portion incorporating one or more ridges, the or each ridge forming the perimeter of a design, the perimeter defining an area suitable for housing a baked good; said design enclosed by side walls on at least the base portion; said lid portion cooperating in use, when the base and lid portions are brought into cutting engagement, whereby a cutting surface of the lid portion cooperates with the or each ridge to cut any goods caught between the or each ridge and the cutting surface.

### FIELD OF THE INVENTION

The device according to the invention relates to a sandwich cutter and mould. The device in particular, allows a sandwich or the like to be cut, shaped and sealed into a desired shape.

### BACKGROUND TO THE INVENTION

Generations of parents have struggled with ensuring their children eat a healthy and balanced diet. For many, moreover, it is difficult to encourage their children to even eat the volume of food required to meet their nutritional needs. In order to solve this problem numerous inventions and food based products have sought to entice children into eating, by making food seem more fun or appealing. A well accepted means of improving a child's interest in a food stuff is to make it resemble a cartoon character or face. This method has been exemplified with potato chips shaped to form smiling faces, or luncheon meat in the shape of bears. The limitation of the latter, is that although the meat portrays a smiling face of a bear, the meat is likely enclosed within a sandwich where it can no longer be seen, thus losing the inherent appeal the face provides.

In order to overcome this limitation, the current invention seeks to make the sandwich itself resemble an interesting and exciting image. Not only does the device according to the current invention cut the sandwich into a creative shape—and in doing so potentially remove the crusts which so many children dislike—but it will also emboss the surface of the sandwich with child-friendly designs.

Furthermore, the current design seals the perimeter of the sandwich helping to prevent the contents from spilling out of the sandwich and onto clothes or the surrounding area. Use of this invention promotes a better fed, cleaner and happier child.

An additional usage for shaping sandwiches and the like, is to provide foodstuffs in the shape of a trade mark or logo. Additionally, shaping the sandwich can aid packaging of the foodstuff.

### SUMMARY OF THE INVENTION

In a first broad independent aspect the invention provides a mould for a sandwich, the mould comprising: a base portion and a lid portion; said base portion incorporating one or more ridges, the or each ridge forming the perimeter of a design, the perimeter defining an area suitable for housing a baked good; said design enclosed by side walls on at least the base portion; said lid portion cooperating in use, when the base and lid portions are brought into cutting engagement, whereby a cutting surface of the lid portion cooperates with the or each ridge to cut any goods caught between the or each ridge and the cutting surface.

This is particularly advantageous because it provides a quick and effective way of cutting and moulding a sandwich into a shape that a child would find enticing. As the two-piece mould is pressed together in cutting engagement the sandwich is cut into the desired shape. During this cutting procedure the crusts of the sandwich, which many children find particularly unpleasant to eat, are removed from the sandwich. Furthermore, having side walls enclosing the perimeter of the design is particularly advantageous because it means that the crusts and sandwich offcuts that are removed from the sandwich during the cutting engagement are contained within the area between the perimeter of the design and the side walls of the mould. After the sandwich is removed from the centre of the mould, the crusts and sandwich off cuts can be disposed of by inverting the base of the mould into a bin or other means of disposal. This enables the unwanted remnants to be disposed of quickly and easily, and reduces any mess created during the moulding process.

Preferably, the mould further comprising sealing platforms on the lid portion and the base portion following the contours of and proximate to the internal circumference of the or each ridge, in use, said sealing platforms cooperate to compress the goods caught there between. This is particularly advantageous because it effectively creates a seal around the periphery of the finished sandwich which prevents the ingredients of the sandwich from leaving the sandwich. Therefore, as the child eats the moulded sandwich the fillings do not slip or fall out of the bottom of the sandwich. This ensure that the child can eat all the nutritious ingredients of the sandwich and limits the mess the child can create.

More preferably, wherein the distance between the sealing platforms is between about 1-1.5 mm when in a fully closed configuration. This is particularly advantageous because independent investigations have shown this distance within the sealing platforms creates the optimal compression, effectively sealing the sandwich ingredients within the sandwich but with minimal possibility of damaging the integrity of the bread.

Preferably, wherein at least one of the base portion or the lid portion incorporate one or more forming regions which, when the mould is in a closed configuration, extend into said area between said lid portion and said base portion to shape the baked good contained within said area. This is particularly advantageous because it embosses a pattern onto the shaped sandwich adding to the detail of the design and increasing the attraction the child will have for the sandwich. The forming regions will create the details of the design such as eyes, nose and mouth.

Preferably, wherein the lid portion is of dimensions greater than the base portion, enabling the lid portion to slide over the base portion in contiguous engagement to close the mould. This is advantageous because it enables the mould to be reused without disposing of the sandwich offcuts between each use. The sandwich offcuts will fall into the base portion of the mould after cutting and therefore if the base portion was of dimensions greater than the lid portion, then the side walls of the base portion would slide over the lid portion. In this instance, the previous sandwich offcuts might impede correct closure of the mould.

Preferably, wherein the or each ridge comprises an inner and outer surface, said outer surface inclined so that the intersection of the inner surface and the outer surface forms a cutting edge. This is particularly advantageous because it improves the cutting action of the mould and helps move the crusts away from the sandwich.

Preferably, wherein the inner surface and the outer surface of said ridge have an intersection angle of between 5-45 degrees.

Preferably, wherein said design and said side walls are separated by between about 1-3 cm. This is advantageous because it provides enough space for the offcuts of the sandwich to be housed before they are disposed of. Having a greater distance enables more sandwiches to be cut and moulded before the offcuts have to be disposed.

Preferably, wherein said design is detachable from said side walls. This is particularly advantageous because it enables the user to alter the design of the sandwich whilst using the same mould apparatus. Changing the design regularly will keep the child engaged and interested in the sandwiches. Therefore, being able to change the design portions of the mould whilst maintaining the same side wall containers is very beneficial.

Preferably, wherein said cutting surface of said lid portion consists of a first surface and a second surface at right angles to each other, in use, the cutting engagement consists of the inner surface of the or each ridge sliding across the first surface in frictional contact until said cutting edge makes contact with said second surface. This is particularly advantageous because it improves the efficacy of the cutting, ensuring the crusts are fully removed from the moulded sandwich.

### BRIEF DESCRIPTION OF THE FIGURES

The invention will now be described in detail, with reference to the figures, of which:

FIG. 1 shows a first embodiment of a sandwich mould in perspective view; and

FIG. 2 shows a first embodiment of a sandwich mould in a second perspective view; and

FIG. 3 shows a first embodiment of a sandwich mould 10, in use, in cross-sectional side view.

### DETAILED DESCRIPTION OF THE FIGURES

The current invention provides a mould for shaping a sandwich or similar products. The mould comprises a lid portion and a base portion. The mould has a fully open and a fully closed configuration. When in a fully closed configuration the lid portion and the base portion define a volume suitable for housing a sandwich or similar baked good. Raised walls within both the base portion and optionally the lid portion create a perimeter for the overall sandwich design and provide a cutting edge or edges, to cut the bread to the desired shape. In use, the unshaped sandwich is placed into the base portion, resting on the raised walls of the base portion, and the lid portion and the base portion are pressed together in cutting engagement. Sealing platforms at the top of the internal walls compress the bread caught between the platforms, creating a sealed edge. From here on by the term sealed edge we mean layers of bread compressed together so that fillings contained within the bread layers do not fall out. The cutting edge, optionally a ridge incorporated into the wall of the base portion, severs the bread around the periphery of the sealed edge, removing the unwanted crusts of the sandwich. A series of projections or formed regions extending inwards from the lid portion and optionally the base portion, emboss a design into the bread. The result is a sandwich, or similar product, optionally with crusts cut off, edges sealed to keep the contents inside, and a pattern, face or logo embossed into the surface.

To provide clarity, the components of the invention which are common to each figure have retained identical numerical references throughout all figure descriptions.

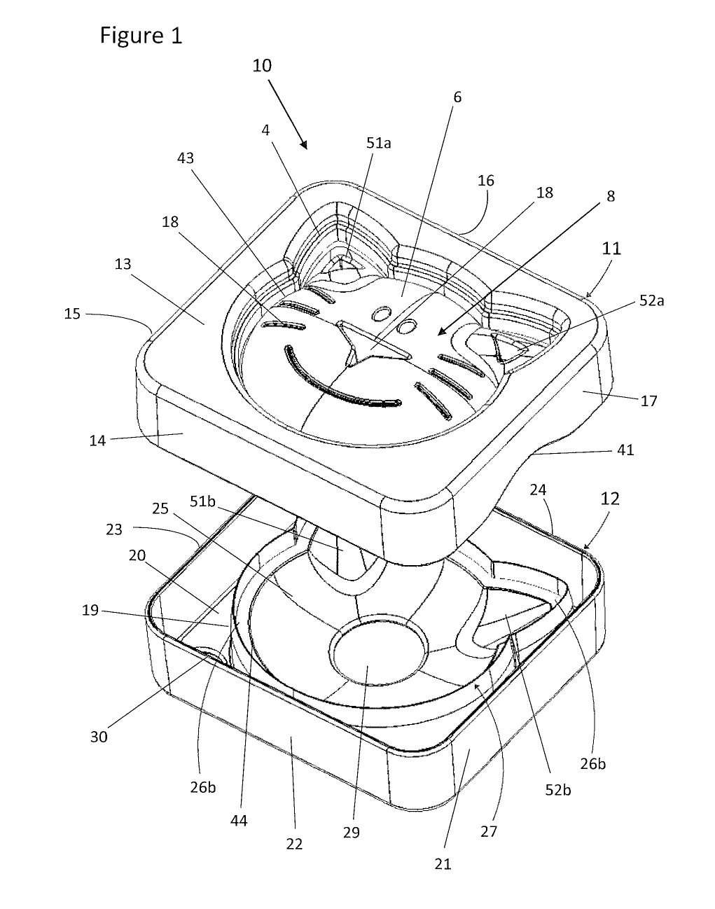

FIG. 1 shows an embodiment of a sandwich mould 10 in perspective view. The lid portion 11 is shown lifted from the base portion 12, so that the mould 10 is in an open configuration. The lid portion 11 has a substantially square planar upper plate 13, with rectangular planar side walls 14, 15, 16 and 17 extending perpendicularly from the upper plate 13 in a downwards direction when orientated for use. At the centre of the upper plate 13 is an upper design 8 formed from a substantially domed surface 6. The apex of the domed surface 6 is on the same plane as the upper plate 13, with the perimeter 43 of the domed surface 6 on a plane inferior to that of upper plate 13. In the current embodiment, the perimeter 43 of the domed surface 6 is substantially circular with the addition of substantially triangular portions 51a and 52a to provide detail to the upper design 8. In the current design, the triangular shapes 51a and 52a represent ears. In an alternative embodiment, the perimeter 43 could be circular, triangular, square or of any shape required.

A number of depressions, such as 18 in the domed surface 6, extend from the domed surface 6 towards the base portion 12 when in a closed configuration, and provide detail in the upper design 8. The depressions 18 can be of different widths and lengths depending on the design 8. In the current embodiment, the depressions 18 are characterised by a wider, triangular depression to represent a cat's nose and a series of thin elongate depressions to represent the cat's mouth and whiskers. In an alternative embodiment, these depressions 18 could be used to create any design including other animals such as dogs, cows, sheep or monkeys, or inanimate objects such as ships, cars or any other suitable objects.

The wall 4 extends downwards as orientated for use, substantially perpendicularly to the upper plate 13. At the base of the wall 4 a sealing platform 26a connects the perimeter 43 of the domed surface 6 to the base of the wall 4. The sealing platform 26a is a planar surface which runs around the exterior of the perimeter 43, substantially parallel to the upper plate 13 and at a plane inferior to the upper plate 13. In the current embodiment, the sealing platform 26a is about 5 mm wide around its entire circumference. In an alternative embodiment, the sealing platform 26a has a width in the range of about 2.5 mm-12.5 mm.

In the current embodiment, the side walls 15 and 17 feature a concave shaped edge 41 to enable the user to grip the base portion 12 when the lid portion 11 is encompassing the base portion 12 in a closed configuration. The concave shaped edge 41 facilitates opening of the sandwich mould 10.

The base portion 12 has a substantially square planar lower surface 20, with rectangular planar side walls 21, 22, 23 and 24 extending perpendicularly from the lower surface 20, in an upwards direction when orientated for use. In a preferred embodiment, the lower surface 20 is a slightly smaller square than upper plate 13, so that in use, on closure of the mould, the side walls 14, 15, 16, and 17 pass over the side walls 21, 22, 23 and 24. In a preferred embodiment the side walls 21, 22, 23 and 24 are of greater height than the side walls 14, 15, 16, and 17, and therefore at rest the upper plate 13 of the lid portion 12 will rest upon the side walls 21, 22, 23 and 24.

At the centre of the lower surface 20 is a concavity 25, with a perimeter 44. At the centre of the concavity 25 is a central aperture 29 suitable for the insertion of a finger or thumb. In the current embodiment, the aperture 29 is circular, however alternatively the aperture 29 could be oval, square, rectangular or any other suitable shape. The aperture 29 is on the same plane as the lower surface 20 and the perimeter 44 is on a plane superior to that of the lower surface 20. The perimeter 44 is shaped to be substantially identical to the perimeter 43 of the domed surface 6 on the lid portion 11. In the current embodiment, the perimeter 44 of the concavity 25, is substantially circular with the addition of substantially triangular portions 51b and 52b to provide detail to the design 8. In an alternative embodiment, the perimeter 44 could be circular, triangular, square or of any shape required. A planar sealing platform 26b runs around the exterior of the perimeter 44, substantially parallel to the lower surface 20 and at a plane superior to the lower surface 20. In the current embodiment, the sealing platform 26a is about 5 mm wide. In an alternative embodiment, the sealing platform 26a is in the range of about 2.5 mm-12.5 mm. In the current embodiment, the sealing platforms 26a and 26b are substantially parallel and of equal width. In an alternative embodiment, the sealing platforms 26a and 26b can be at an inclined angle, so that, in a closed configuration, the peripheral edges of the sealing platforms 26a and 26b are closer together than the interior edges of the sealing platforms 26a and 26b.

A wall 19, extending perpendicularly from the lower surface 20 to the outer edge of the sealing platform 26b, runs around the circumference of the sealing platform 26b.

A ridge 27 is attached to the top of the wall 19 extending substantially perpendicular from the lower surface 20. The ridge comprises an inner surface 61 and an outer surface 62. The confluence of the inner surface 61 and the outer surface 62 forms a cutting edge 63. In a preferred embodiment, the inner surface 61 is substantially perpendicular to the lower surface 20 of the base portion 12 and the outer surface is inclined so that the intersection of the inner surface 61 and the outer surface 62 forms the cutting edge 63. In an embodiment, the angle between the inner surface 61 and the outer surface 62 is between about 5-45 degrees. In an alternative embodiment, the inner surface 61 and the outer surface 62 of the ridge 27 are substantially parallel.

In the current embodiment, the ridge 27 is continuous with the wall 19. In an alternative embodiment, the ridge 27 is parallel to the wall 19 but exterior to the wall 19. In a preferred embodiment, the ridge 27 is of dimensions slightly greater than those of the wall 4, so that, in use, the wall 4 can sit within the boundary of the ridge 27. In a preferred embodiment, the inner surface 61 of the ridge 27 has a close frictional fit with the outer surface of the wall 4, when in a closed configuration. This has the added benefit of improving the cutting of the bread.

In a preferred embodiment, the ridge 27 is a blade. The ridge 27 can be formed from wood, plastic, metal, glass or any other suitable compound. The ridge 27 can be integrally formed with the wall 19 or can be attached by a suitable attachment means. In an alternative embodiment, the ridge 27 has a slightly blunted cutting edge so that it can still cut the baked goods inside the mould 10 but not present a danger to the user.

A hole 30, in the lower surface 20 helps prevent pressure from building up as the lid portion 11 is pressed onto the base portion 12, in use. Furthermore, the hole 30 assists the user when removing the crusts of the sandwich after successful use of the mould 10. The crusts which are resting on the lower surface 20 can be dislodged from their location by the insertion of a finger into the hole 30. In the current embodiment, the hole 30 is in the left hand corner as shown in FIG. 1, however, in an alternative embodiment the hole 30 could be present in any part of the lower surface 20 or the upper plate 13.

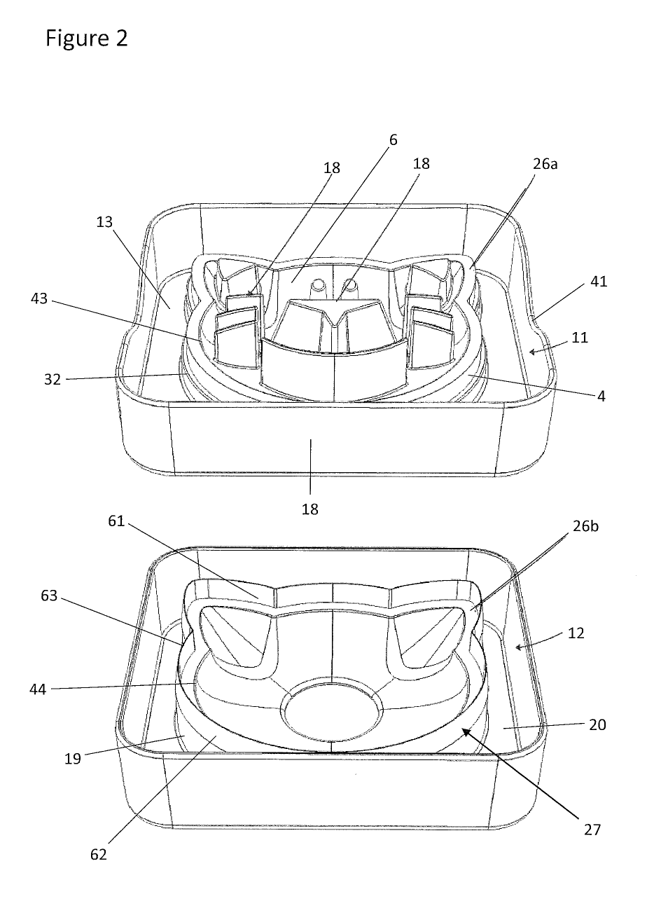

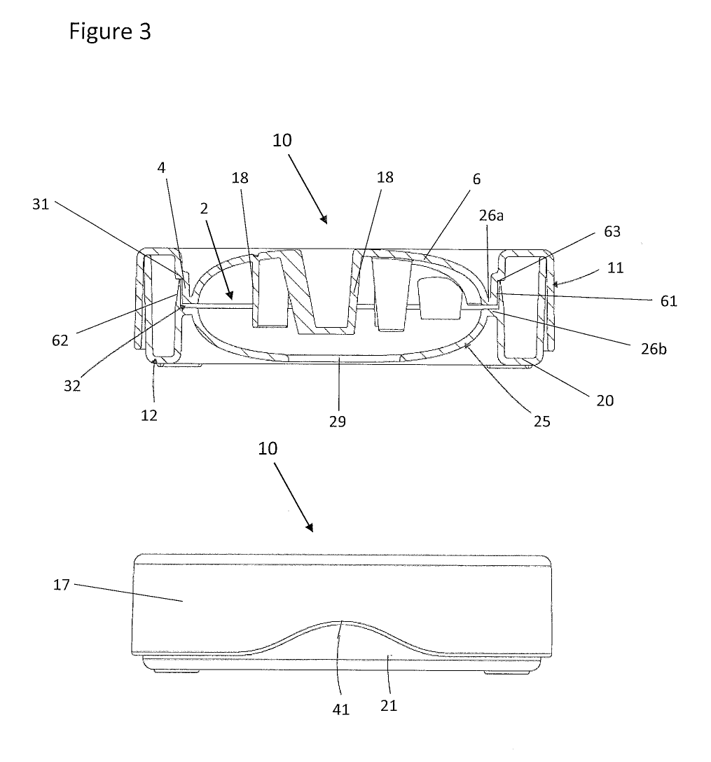

FIG. 2 shows the first embodiment of a sandwich mould 10 in perspective view. The lid portion 11 has been inverted to show the underside of the lid portion 11, compared to the view of FIG. 1. The depressions 18 which extend from the domed surface 6 to form the design 8 are clearly visible. The planar sealing platform 26a extends around the perimeter 43 of the domed surface 6. A step incorporated into the wall 4 creates a ledge 31 (see FIG. 3), around the periphery of the sealing platform 26. The ledge 31 is parallel to, but in a superior plane from the sealing platform 26a, as configured for use. The distance between the sealing platform 26a and the ledge 31 is such that, in use, the cutting edge 63 of the ridge 27 comes in contact with the ledge 31 before the sealing platforms 26a and 26b come into contact. Furthermore, when fully closed, the sealing platforms 26a and 26b define an area 32. The height of the ridge 27 and the distance from the sealing platform 26a and the ledge 31 is calculated to optimise the size of area 32 and in doing so optimise the compression of the bread. Testing has shown that the optimum height of area 32—the distance between sealing platforms 26a and 26b when in a fully closed configuration—is between 1-1.5 mm. This optimal height leads to compression of the bread between the sealing platforms, sealing the edges of the sandwich and preventing the internal ingredients from falling out, but does not risk causing the bread falling apart. In a preferred embodiment, the sealing platforms 26a and 26b are 5 mm in width, providing optimal sealing of the sandwich without losing too much space for sandwich fillings.

FIG. 3 shows the first embodiment of a sandwich mould 10, in use, in cross-sectional side view. In closed configuration the domed surface 6 and the concavity 25 cooperate to define a cavity 2. The prepared sandwich is placed into the base portion 12 so that the sandwich rests upon the cutting edge 63 of the ridge 27. As the lid portion 11 is pressed onto the base portion 12, the projections 18 in the lid portion 11, which form the design 8, will press into the sandwich altering its shape and forcing the sandwich into the concavity 25 in the base portion 12. The sealing platform 26a will be pushed towards sealing platform 26b. The inner surface 61 of the ridge 27 will slide over the wall 4 and the cutting edge will make contact with the ledge 31 cutting the bread caught between the ridge 27 and the ledge 31. The inner surface 61 and the cutting edge 63 are brought into cutting engagement with the wall 4 and the ledge 31 which form a cutting surface.

The cut bread will be disconnected from the bread contained within the perimeter of the ridge 27, and will fall onto the lower surface 20. The sealing platforms 26a and 26b will compress the bread in area 32, effectively sealing the perimeter of the sandwich. The projections 18 cause the bread in the cavity 2 to alter shape conforming to the shape of the concavity 25 and becoming embossed with the design 8, created by the depressions 18 in the domed surface 6. The result is the production of a shaped sandwich with sealed edges, of width corresponding to the width of the sealing edges, and an embossed design on its upper surface. To remove the sandwich, the user removes the lid portion 11, gripping the base portion 12 at the regions exposed by the concave edge 41. The cut and moulded sandwich will remain in the concavity 25 of the base portion 12. The sandwich will be cut and sealed around its perimeter in line with ridge 27. The design 8 will be embossed onto the surface of the sandwich where the projections 18 were pressed into the sandwich. The user can then insert a finger or thumb into the aperture 29, raising the sandwich from the concavity 25. The portions of bread cut off by the ridge 27 will remain on the lower surface 20 in the base portion 12 for easy disposal.

In an alternative embodiment, additional depressions could project from the concavity 25 of the base portion 12 into the cavity 2, as orientated for use. This would emboss additional patterns on the reverse of the sandwich.

In a preferred embodiment, the sandwich mould 10 can be formed of a polymer material such as cast plastic. Alternatively, the sandwich mould could be made from metal, glass, wood or any other suitable material.

In an alternative embodiment, the lid portion and the base portion are connected by a hinge region along any edge.

In a preferred embodiment, the inner surfaces of the lid portion 11 and the base portion 12 are coated in a hydrophobic polymer to prevent foodstuff getting stuck onto the surfaces and enabling easy cleaning.

In a preferred embodiment, the sandwich mould 10 is heat stable and microwave friendly. This enables the mould 10 to be used to make hot sandwiches such as those with melted cheese. In addition, being heat stable, enables the mould 10 to be cleaned by placing it in the dishwasher or similar means without it warping and losing its shape.

In an alternative embodiment, the ridge 27 is attached to the wall 4 on the lid portion 11. To accommodate this alteration, the ridge 31 encompasses the wall 19 below the sealing platform 26b.

In an alternative embodiment, the design 8 is detachably attached to the sandwich mould 10 so that the design 8 can altered quickly and easily by removing the design 8 from the lid portion 11 and the base portion 12 and attaching a new design. In an embodiment, the design 8 is attached to the upper plate 13 by a clip or fastening device.

1. A mould for a sandwich, the mould comprising:
a base portion and a lid portion;
said base portion incorporating one or more ridges, the or each ridge forming the perimeter of a design, the perimeter defining an area suitable for housing a baked good;
said design enclosed by side walls on at least the base portion;
said lid portion cooperating in use, when the base and lid portions are brought into cutting engagement, whereby a cutting surface of the lid portion cooperates with the or each ridge to cut any goods caught between the or each ridge and the cutting surface.

2. A mould according to claim 1, further comprising sealing platforms on the lid portion and the base portion following the contours of and proximate to the internal circumference of the or each ridge, in use, said sealing platforms cooperate to compress the goods caught there between.

3. A mould according to claim 2, wherein the distance between the sealing platforms is between about 1-1.5 mm when in a fully closed configuration.

4. A mould according to claim 2, wherein the sealing platforms are of a width of between about 2.5-12.5 mm.

5. A mould according to claim 1, wherein at least one of the base portion or the lid portion incorporate one or more forming regions which, when the mould is in a closed configuration, extend into said area between said lid portion and said base portion to shape the baked good contained within said area.

6. A mould according to claim1, wherein the lid portion is of dimensions greater than the base portion, enabling the lid portion to slide over the base portion in contiguous engagement to close the mould.

7. A mould according to claim 1, wherein the or each ridge comprises an inner and outer surface, said outer surface inclined so that the intersection of the inner surface and the outer surface forms a cutting edge.

8. A mould according to claim 7, wherein the inner surface and the outer surface of said ridge have an intersection angle of between 5-45 degrees.

9. A mould according to claim 1, wherein said design and said side walls are separated by between about 1-3 cm.

10. A mould according to claim 1, wherein said design is detachable from said side walls.

11. A mould according to claim 7, wherein said cutting surface of said lid portion consists of a first surface and a second surface at right angles to each other, in use, the cutting engagement consists of the inner surface of the or each ridge sliding across the first surface in frictional contact until said cutting edge makes contact with said second surface.
